(19) United States
(12) Patent Application Publication
(10) Pub. No.: US 2016/0128813 A1
(43) Pub. Date: May 12, 2016

(54) THE COMBINATION OF A PHYSICAL MODEL OF A SET OF A PATIENT'S TEETH AND AN ELONGATED IMPLANT ANALOG, AN ELONGATED IMPLANT ANALOG AND A METHOD OF MAKING A PHYSICAL MODEL OF A SET OF TEETH

(71) Applicant: Elos Medtech Pinol A/S, Gorlose (DK)

(72) Inventors: Christian Scharfe Thomsen, Copenhagen (DK); Henrik Andersen, Skibby (DK)

(21) Appl. No.: 14/782,385

(22) PCT Filed: Apr. 2, 2014
(86) PCT No.: PCT/DK2014/050079

§ 371 Date: Oct. 5, 2015

(30) Foreign Application Priority Data
Apr. 4, 2013 (DK) PA 2013 70186

(51) Int. Cl. A61C 13/34; A61C 13/265; A61C 13/00

(52) U.S. Cl. CPC A61C 13/34; A61C 13/0004; A61C 13/0019; A61C 13/2656

(57) ABSTRACT

The invention relates to a physical model of a person's teeth and to an analog configured to mutually snap engage upon insertion of the analog to a the desired depth into a hole in the physical model representative of an implant in the person's bone, with a peripheral or annular space between the analog and the model in the hole between the location of the snap engagement and a distal portion that together with the snap engagement define contact areas serving to keep the analog from sideways or turning movements within the hole.

### FIELD OF THE INVENTION

Finalizing a dental restoration which is subsequently fixed to an implant in the bone of a person is typically done using a physical model of the person's teeth. A method for making such a physical model of a full or partial set of the person's teeth typically involves a first step of scanning the implant region with teeth and an abutment piece inserted into the implant. This is often done using an intra-oral scanner.

The scanning is performed to obtain a three dimensional digital representation of the person's teeth, including of the implant region, following which a virtual model of the person's teeth is computer generated on the basis of this three dimensional representation, with a virtual region in the implant region representing the orientation of the implant. The physical model is then manufactured, such as by 3D-printing, on the basis of the virtual model, with a physical region that corresponds to the virtual region and having a hole representing the orientation of the implant. A so-called implant analog mating the hole is then inserted into the hole and to which the dental abutment is fixed temporarily, following which finalizing work, such as a manual modelling by application of a surface coating onto the dental abutment, is initiated for finalizing the restoration.

Modelling is performed manually in a dental laboratory, and is generally considered laborious and requiring high care to yield a dental restoration that not only matches neighbouring teeth but which also ensures that the person will keep his normal “bite”, which is one reason for making a complete physical model of all the person's teeth.

### BACKGROUND OF THE INVENTION

It is a problem with the conventional solutions available that the dental staff working at the dental laboratory cannot verify that the analog is at the correct position in the model. Sometimes the analog will shift position axially in the hole and the dental staff is unable to readily verify at any time that the analog is in the correct axial position.

### OBJECT OF THE INVENTION

It is an object of the present invention to provide a solution to the aforementioned problem, which solution should at the same time still allow for an easy insertion of the analog into the hole, without the need to overcome high frictional forces between the hole and the elongated analog. This is in accordance with the invention achieved in that the physical model and the analog are configured to snap engage upon insertion of the analog into the hole at the desired depth, and also in that there is a peripheral or annular space between the analog and the model in the hole between the location of the snap engagement and a distal portion that together with the snap engagement defines contact areas serving to keep the analog from sideways or turning movements within the hole. On inserting the analog into the physical model the dental worker holding the model in his hand will recognise the feel of the snap engagement, and any simultaneous audible click sound resulting from the release of internal stresses in the material of the model/analog, as a signal that the analog has reached the desired position inside the hole, and the dental finalizing procedure can then be initiated with the staff knowing that the analog will not suddenly shift its position in the hole. The snap engagement may be located near one or the other end of the analog; in a preferred embodiment the snap engagement is by a radial projection of the analog engaging a peripheral groove of the physical model inside the hole.

Preferably, an additional signal is made available when configuring the model and the analog such that when the analog is at the desired insertion depth an end face of the analog is flush with a base face of the physical model, and a person swiping his fingers across the base face will recognize this is a signal of the analog having reached the correct insertion depth. It is also preferred that the snap engagement is at separate locations along the periphery of the analog whereby only a local deformation of the physical model, which is typically of a material softer than that of the analog, is required on inserting the analog until the model and the analog snap into engagement.

Preferably, the analog has a face configured to rest against an internal abutment face in the hole, to prevent further axial movement of the analog in the hole.

The invention relates to a combination of an analog and a physical model as referred to above, and also to an analog as such, configured to allow for a snap engagement.

The invention additionally relates to a method of making the combination referred to above, comprising a series of steps involving the scanning of the person's teeth and forming the model with a through hole and providing an analog with a signalling portion suitable for providing a visual, audible or tactile signal, after which the physical model is generated, such as by 3D-printing, and the analog is inserted axially into the through hole until reaching a depth where the signalling portion gives off a signal indicate of the analog having reached the desired depth as required for the finalizing of the dental abutment. The signal may be provided as a visual or tactile signal by the signalling portion being flush with a base face of the physical model, and/or as an audible signal through the sound of a snap engagement as discussed above.

### BRIEF DESCRIPTION OF THE FIGURES

The combination, method and analog according to the invention will now be described in more detail with regard to the accompanying figures. The figures show one way of implementing the present invention and is not to be construed as being limiting to other possible embodiments falling within the scope of the attached claim set.

FIG. 1 is a photo showing a part of a patient's gingival area,

FIG. 2 is a perspective view of one analog according to the invention,

FIG. 3 is a perspective top view of a physical model of the invention, with the analog of FIG. 2 ready for insertion,

FIG. 4 is a perspective bottom view of the physical model of FIG. 3, with the analog of FIG. 2 mounted therein,

FIG. 5 is a top view of the physical model with the analog of FIG. 2 mounted therein, and

FIG. 6 is a side cross-sectional view of the physical model with the analog of FIG. 2 mounted therein.

### DETAILED DESCRIPTION OF AN EMBODIMENT

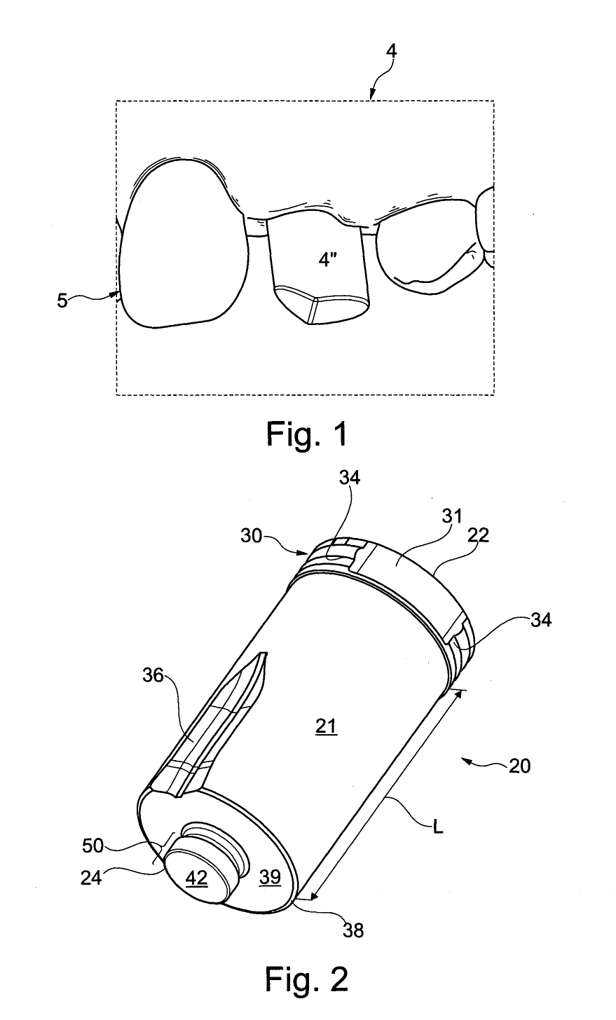

FIG. 1 shows a part of a patient's gingival area with teeth 5 and a surgically implanted implant (not shown) in an implant region 4 of the patient's bone. A scan abutment piece 4″ has been mounted with one end fixed to the implant. The abutment piece 4″ projects from the implant with an orientation as defined by the structure of the implant and the surgical procedure.

A method for making a physical model of a full or partial set of the patient's teeth involves a first step of scanning the implant region 4 with teeth 5 and abutment piece 4″ shown in part in FIG. 1. This may preferably be done using an intra-oral scanner, such as marketed by 3Shape™.

The physical model is then made and used in a dental laboratory for the purpose of finalizing a dental restoration which is subsequently fixed to the implant. For this purpose use is conventionally made of a so-called implant analog which is inserted into a hole in the physical model and to which the dental abutment is fixed temporarily, following which the aforementioned finalizing work, such as modelling, is initiated for making a restoration.

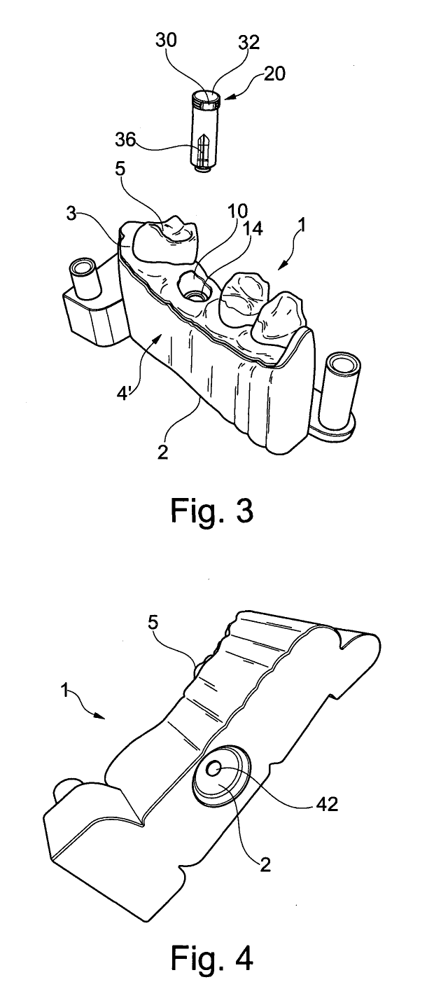

More specifically, the method of making the physical model according to the present invention involves the steps of providing an elongated cylindrical implant analog 20, as shown in FIG. 2, usually of titanium and internally configured to mate with a fixture part of the dental restoration. The analog 20 has a first end 22 and a second opposite end 24. Before or after this step the above-mentioned scanning is performed to obtain a three dimensional digital representation of the person's teeth 5, including of the implant region 4, following which a virtual model of the person's teeth 5 is computer generated on the basis of this three dimensional representation, with a virtual region in the implant region representing the orientation of the implant. The physical model, as shown by way of example in FIGS. 3 and 4, is then manufactured, such as by 3D-printing, on the basis of the virtual model, with a physical region 4′ that corresponds to the virtual region and having a hole 10 representing the orientation of the implant and mating the implant analog 20. The physical model 1 has a base face 2 and an opposite gingival region 3.

According to the invention, the hole is formed as a through hole 10 extending from the base face 2 to the opposite gingival part 3 and includes an internal abutment face 14, as seen best in FIG. 6. The implant analog 20 is then inserted in the direction from the gingival part 3 into the through hole 10 to a desired depth, at which point a signalling is provided to the operator by a signalling portion of the analog 20, as described further below.

FIG. 6 is a cross-sectional side view showing the combination of the physical model 1 and the elongated implant analog inserted into the physical model 1 to simulate a dental implant. The analog 20 is hollow and internally configured to mate with a fixture part of a dental restoration 100 to be finalized using the physical model 1; the internal shape and configuration of the analog 20 is typically selected in accordance with the type of implant.

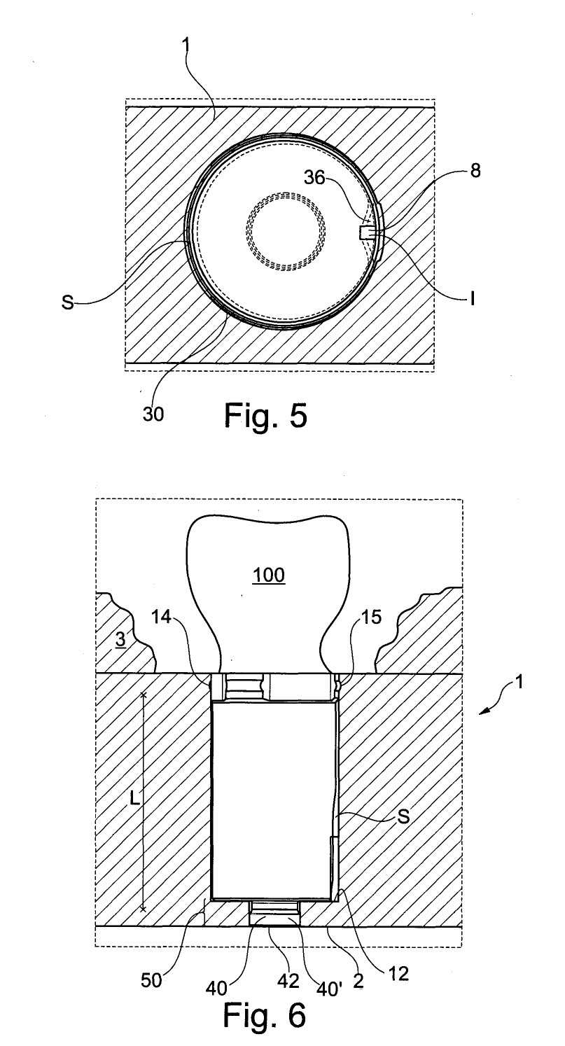

The analog 20 has a stop section 30 located between the first 22 and second 24 end and including a face 34 that is oriented in the general direction away from the first end 22, as seen also in FIG. 2 and the physical model 1 is preferably manufactured with a mating internal abutment face 14 located in the through hole 10. The physical model 1 and the analog 20 are also provided with mating rotation restricting faces 8, 36, shown also in FIG. 5, which engage to prevent any rotation of the analog 20 inside the hole 10 and ensure that the analog is only insertable with the correct rotational orientation to reflect the orientation of the patient's implant.

In the shown embodiment the aforementioned stop section 30 and the abutment face 14 are complementary and define a snap engagement for maintaining a desired insertion depth of the analog 20 in the hole 10. To this effect, the physical model 1 may be manufactured with an indentation that extends along the periphery of the hole 10 and defines the internal abutment face 14. The indentation receives a lateral projection on the analog 20, which projection has the face 34 and which snaps into the indentation by the material of the physical model 1 yielding slightly during the insertion of the analog 20 into the hole 10. The snap engagement is preferably only at separate discrete locations along the periphery of the analog 20, at one common level along the length of the analog 20, by the analog having intermediate areas 31 without the lateral projection, as shown in FIG. 2.

As shown in FIG. 6, the physical model 1 and the analog 10 are configured to provide for a peripheral annular space S between the physical model 1 and the analog 20 inside the hole along a length L, which may by way of example be in the order of 2-12 mm, of the analog 20 extending to a distal portion 40 distant from the snap engagement. The configuration is also such that only the distal portion 40 and the stop section 30 contact the physical model 1 in the hole 10 to maintain the analog 20 against sideways movement or turning inside the hole 10. This involves the advantage of a very low resistance against insertion of the analog 20 into the hole 10.

Also, the analog 20 preferably has an end portion 50 of reduced cross-section, compared to the diameter of the remaining portion of the analog 20 that includes the second end 24 and the distal portion 40. A transition to the end portion 50 is defined by a transition face 39 oriented towards the second end 24 and preferably perpendicular to the length of the analog 20. The physical model 1 preferably includes a further internal abutment face 12 in said through hole 10 and which mates the transition face 39. Preferably, when in said snap engagement the analog 20 will also rest against the internal abutment face 12 of the model 1.

Preferably, the first end 22 includes an indicator I confirming correct rotational alignment of the analog 20, i.e. that the rotation restricting faces 8, 36 are aligned and mate after the axial insertion of the analog 20 into the hole 10, by being in correspondence with a mark on the gingival part 3 of the physical model 1.

It is preferred that the end face 42 of the analog 20 at the second end 24 is visible and made to be flush with the base face 2 when the analog 20 is maintained at the desired insertion depth by the snap engagement. This is one reason for providing the hole 10 as a through-going hole. Alternatively or additionally a peripheral end face 32 at the first end 22 of the analog 20 is made to be flush with a face portion 15 of the physical model 1 surrounding the through hole 10. In this context it will be understood that the second end 24 may define a signalling portion for providing in this case a tactile signal, the user being able to manually verify correct insertion of the analog 20 by swiping a finger along the base face 2 and also visually confirming that the face 2 is flush with the end face 42. As the aforementioned projections snaps into the indentation to provide the snap engagement i) a distinct audible sound and/or ii) a tactile signal felt by a person holding the physical model 1 in his hand may alternatively or additionally be given off by proper selection of the geometry and material of the analog 20 and of the physical model 1. In this manner the snap engagement provides for another type of signalling. Again, this signal is indicative to the operator that the analog 20 is in correct position, after which work on the dental restoration 100 can be initiated without the risk that the dental abutment 100 will move during the modelling.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. The combination of a physical model of a set of a patient's teeth and an elongated implant analog for insertion into said physical model to simulate a dental implant, said analog having a first end and a second opposite end and being internally configured to mate with a fixture part of a dental restoration to be finalized using said physical model, said analog having a stop section located between said first and second end and including a face oriented away from said first end, said physical model having a base face and an opposite gingival part, a through-going hole extending from said base face to said opposite gingival part, said physical model including an internal abutment face in said through-going hole, and said physical model and said analog having mating rotation restricting faces restricting rotation of said analog inserted into said hole, said stop section and said abutment face being complementary to define a snap engagement for maintaining a desired insertion depth of said analog in said hole, said physical model and said analog being configured to provide i) for a peripheral space between said physical model and said analog inside said hole along a length of said analog extending to a distal portion distant from said snap engagement, and ii) for said distal portion to contact said physical model in said hole, to maintain said analog against sideways movement in said hole.

2. The combination of claim 1, said analog having a reduced cross-section end portion including said second end and said distal portion, a transition to said end portion being defined by a transition face oriented towards said second end, said physical model including a further internal abutment face within said through-going hole and configured for mating said transition face.

3. The combination according to claim 1, said first end and/or said second end including an indicator marking I indicating when aligned with a marking on said physical model proper rotational alignment of said analog.

4. The combination according to claim 1, an end face of said analog at said second end being visible and flush with said base face when said analog is maintained at said desired insertion depth by said snap engagement.

5. The combination according to claim 1, said snap engagement being at separate locations along a periphery of said analog, such as at one common level along the length of said analog.

6. The combination according to claim 1, said physical model being of a material softer than said analog.

7. The combination according to claim 1, said analog being of metal, such as Titanium or a metal alloy.

8. An elongated implant analog for insertion into a physical model of a set of a patient's teeth to simulate a dental implant, said analog having a first end and a second opposite end with an end face and being internally configured at said first end to mate with a fixture part of a dental restoration to be finalized using said physical model, said analog having on the outside thereof between said first and second end a face extending along a portion of the periphery of said analog and oriented away from said first end, and an axial face extending along a length thereof, said analog having a reduced cross-section end portion including said second end, a transition to said reduced cross-section end portion being defined by a transition face oriented towards said second end.

9. The implant analog of claim 8, said reduced cross-section end portion including a distal portion having a radially projecting peripheral face.

10. A method of making a physical model of a set of teeth of a person having a dental implant, the physical model being for the finalizing of a dental restoration to be mounted to the implant, the physical model having a base face and an opposite gingival part, the method including the steps of:
providing an elongated implant analog internally configured to mate with a fixture part of the dental restoration, the implant analog having a first end and a second opposite end, the second opposite end including a signalling portion for providing a visual, audible or tactile signal,
scanning the person's teeth to obtain a three dimensional representation of the person's teeth, including of an implant region with said the implant,
generating a virtual model of the person's teeth from the three dimensional representation, with a virtual region in the implant region representing the orientation of the implant,
manufacturing, such as by 3D-printing, on the basis of the virtual model the physical model of the person's teeth, with a physical region that corresponds to the virtual region and having a hole representing the orientation and mating the implant analog, the manufacturing comprising
forming the hole as a through-going hole extending from the base face to the opposite gingival part, the through-going hole including an internal abutment face, and
inserting the implant analog in the direction from the gingival part into the through-going hole to a desired depth corresponding to a desired signalling by the signalling portion.

11. The method according to claim 10, the signalling portion being at the second end of the analog, wherein in the desired position an end face of the analog is flush with the base face, to provide the tactile signal inspectable at the base face.

12. The method according to claim 10, comprising the step of maintaining the desired position by a stop section of the analog located between the first and second ends snap engaging the internal abutment face.

13. The method according to the-previous-claim 10, said the snap engagement providing said the audible signal.

14. The combination according to claim 1, wherein said second opposite end includes a signaling portion for providing a visual, audible or tactile signal.

15. The combination according to claim 14, wherein said signal is provided as a visual or tactile signal by said signalling portion being flush with said base face of said physical model.

16. The combination according to claim 14, wherein an additional signal is made available when configuring said physical model and said elongated implant analog such that when said elongated implant analog is at said desired insertion depth an end face of the analog is flush with a base face of the physical model, thereby a person swiping his fingers across the base face will recognize this is a signal of the analog having reached the correct insertion.

17. The combination according to claim 14, wherein said signalling portion at said second opposite end of said analog, provides a tactile signal inspectable at said base face when an end face of said analog is flush with said base face, thereby a person swiping his fingers across the base face will recognize this is a signal of the analog having reached the correct insertion depth.

18. The combination according to claim 14, wherein said signaling portion is given off by proper selection of the geometry and material of the analog and of the physical model.
